(19) United States
(12) Patent Application Publication
(10) Pub. No.: US 2016/0351143 A1
(43) Pub. Date: Dec. 1, 2016

(54) LIQUID CRYSTAL DRIVING CIRCUIT AND LIQUID CRYSTAL DISPLAY DEVICE

(71) Applicant: Wuhan China Star Optoelectronics Technology Co., Ltd., Wuhan, Hubei (CN)

(72) Inventors: Yong TIAN, Shenzhen, Guangdong (CN); Xin ZHANG, Shenzhen, Guangdong (CN); Mang ZHAO, Shenzhen, Guangdong (CN)

(73) Assignee: Wuhan China Star Optoelectronics Technology Co., Ltd., Wuhan, Hubei (CN)

(21) Appl. No.: 14/893,519

(22) PCT Filed: Jun. 30, 2015
(86) PCT No.: PCT/CN2015/082739

§ 371 Date: Nov. 23, 2015

(30) Foreign Application Priority Data
May 28, 2015 (CN) 201510281879.6

(51) Int. Cl. G09G 3/36; G02F 1/1365; G02F 1/1368; G02F 1/133

(52) U.S. Cl. CPC G09G 3/3648; G02F 1/13306; G02F 1/1365; G02F 1/1368; G09G 2310/0251; G09G 2320/0247

(57) ABSTRACT

The present invention discloses a liquid crystal driving circuit, comprising the first to fifth electric switches and the first to fourth capacitors. The first and second capacitors are in the main area, and the third and fourth capacitors are in the sub area. The first to third capacitors are coupled in series. The first and second capacitors, the third and fourth capacitors are respectively coupled in parallel between the first and second electric switches and the common voltage end. The fourth and fifth electric switches are coupled in series between the data end and the second electric switch. The first to fourth electric switches are controlled with the gate control end. The data end is respectively coupled to the first, second and fourth electric switches.

### CROSS REFERENCE

This application claims the priority of Chinese Patent Application No. 201510281879.6, entitled “Liquid crystal driving circuit and liquid crystal display device”, filed on May 28, 2015, the disclosure of which is incorporated herein by reference in its entirety.

### FIELD OF THE INVENTION

The present invention relates to an electronic technology field, and more particularly to a liquid crystal driving circuit and a liquid crystal display device.

### BACKGROUND OF THE INVENTION

In the thin film transistor display device at present, and particularly in the large scale liquid crystal display utilizing the VA (Vertical Alignment) liquid crystal mode, the color washout issue of wide view angle generally exists. For improving the issue, the common method is to divide the pixel unit area into two areas, a main area and a sub area. Under the same gray scale of the video signal, the voltages of the main area and the sub area are different. Therefore, different Gamma curves appear in the main area and the sub area. In the synthetic Gamma curve with the main area and the sub area, the difference between the wide view angle and the view angle in the right front is diminished, and the problem of low color washout is significantly improved. However, utilizing such method to improve the color washout has the problems below: the main area and the sub area respectively have common end voltages of different values. Therefore, the common end voltages of the main area and the sub area cannot be consistent. The flicker situation happens to the liquid crystal display and seriously influences the quality of the liquid crystal display device.

### SUMMARY OF THE INVENTION

An objective of the present invention is to provide a liquid crystal driving circuit and a liquid crystal display for maintaining the consistency of the common end voltages of the main area and the sub area to solve the flicker situation happening to the liquid crystal display, and thus to promote the quality of the liquid crystal display device.

For realizing the aforesaid objective, the technical solution provided by the embodiments of the present invention is:

The present invention provides a liquid crystal driving circuit, employed to charge a pixel unit of a liquid crystal display, and the pixel unit comprises a main area and a sub area, wherein: the liquid crystal driving circuit comprises a first electric switch, a second electric switch, a third electric switch, a fourth electric switch, a fifth electric switch, a first capacitor, a second capacitor, a third capacitor and a fourth capacitor, and the first, second capacitors are located in the main area, and the third, fourth capacitors are located in the sub area, all control ends of the first to fourth capacitors are coupled to a gate control end to receive a control signal, and a first end of the first electric switch is coupled to first ends of the first and second capacitors, and a second end of the first electric switch is coupled to a first end of the second electric switch, and coupled to a data end to receive a charging voltage, and a second end of the second electric switch is coupled to a first end of the third electric switch, and coupled to first ends of the third, and fourth capacitors, and a second end of the third electric switch is coupled to a common voltage end, and all second ends of the first to fourth capacitors are coupled to the common voltage end to receive a common end voltage, and a first end of the fourth electric switch is coupled to the data end to receive the charging voltage, and a second end of the fourth electric switch is coupled to a first end of the fifth electric switch, and a second end of the fifth electric switch is coupled to the first ends of the third and fourth capacitors, and as the control signal activates the first to fourth electric switches to charge the first to fourth capacitors, a positive semi-cycle voltage signal of a voltage signal outputted by the data end conducts the fifth electric switch to perform supplementary charge to the third and fourth capacitors, and a negative semi-cycle voltage signal of the voltage signal outputted by the data end closes the fifth electric switch to stop supplementary charge to the third and fourth capacitors.

The first to fourth electric switches are transistors, and the control ends, the first ends and the second ends of the first to fourth electric switches respectively are gates, sources and drains of the transistors.

The fifth electric switch is a transistor, and a first end of the fifth electric switch is a source of the transistor, and a second end of the fifth electric switch is a drain of the transistor, and a gate of the transistor is coupled to the source of the transistor.

The transistors are all NPN-type transistors.

The fifth electric switch is a diode, and a first end of the fifth electric switch is an anode of the diode, and a second switch of the fifth electric switch is a cathode of the diode.

The present invention further provides a liquid crystal display device, comprising a pixel unit and a liquid crystal driving circuit, employed to charge the pixel unit, and the pixel unit comprises a main area and a sub area, wherein: the liquid crystal driving circuit comprises a first electric switch, a second electric switch, a third electric switch, a fourth electric switch, a fifth electric switch, a first capacitor, a second capacitor, a third capacitor and a fourth capacitor, and the first, second capacitors are located in the main area, and the third, fourth capacitors are located in the sub area, all control ends of the first to fourth capacitors are coupled to a gate control end to receive a control signal, and a first end of the first electric switch is coupled to first ends of the first and second capacitors, and a second end of the first electric switch is coupled to a first end of the second electric switch, and coupled to a data end to receive a charging voltage, and a second end of the second electric switch is coupled to a first end of the third electric switch, and coupled to first ends of the third, and fourth capacitors, and a second end of the third electric switch is coupled to a common voltage end, and all second ends of the first to fourth capacitors are coupled to the common voltage end to receive a common end voltage, and a first end of the fourth electric switch is coupled to the data end to receive the charging voltage, and a second end of the fourth electric switch is coupled to a first end of the fifth electric switch, and a second end of the fifth electric switch is coupled to the first ends of the third and fourth capacitors, and as the control signal activates the first to fourth electric switches to charge the first to fourth capacitors, a positive semi-cycle voltage signal of a voltage signal outputted by the data end conducts the fifth electric switch to perform supplementary charge to the third and fourth capacitors, and a negative semi-cycle voltage signal of the voltage signal outputted by the data end closes the fifth electric switch to stop supplementary charge to the third and fourth capacitors.

The first to fourth electric switches are transistors, and the control ends, the first ends and the second ends of the first to fourth electric switches respectively are gates, sources and drains of the transistors.

The fifth electric switch is a transistor, and a first end of the fifth electric switch is a source of the transistor, and a second end of the fifth electric switch is a drain of the transistor, and a gate of the transistor is coupled to the source of the transistor.

The transistors are all NPN-type transistors.

The fifth electric switch is a diode, and a first end of the fifth electric switch is an anode of the diode, and a second switch of the fifth electric switch is a cathode of the diode.

The liquid crystal driving circuit of the present invention is employed to charge a pixel unit of a liquid crystal display, and the pixel unit comprises a main area and a sub area, wherein: the liquid crystal driving circuit comprises a first electric switch, a second electric switch, a third electric switch, a fourth electric switch, a fifth electric switch, a first capacitor, a second capacitor, a third capacitor and a fourth capacitor, and the first, second capacitors are located in the main area, and the third, fourth capacitors are located in the sub area, all control ends of the first to fourth capacitors are coupled to a gate control end to receive a control signal, and a first end of the first electric switch is coupled to first ends of the first and second capacitors, and a second end of the first electric switch is coupled to a first end of the second electric switch, and coupled to a data end to receive a charging voltage, and a second end of the second electric switch is coupled to a first end of the third electric switch, and coupled to first ends of the third, and fourth capacitors, and a second end of the third electric switch is coupled to a common voltage end, and all second ends of the first to fourth capacitors are coupled to the common voltage end to receive a common end voltage, and a first end of the fourth electric switch is coupled to the data end to receive the charging voltage, and a second end of the fourth electric switch is coupled to a first end of the fifth electric switch, and a second end of the fifth electric switch is coupled to the first ends of the third and fourth capacitors, and as the control signal activates the first to fourth electric switches to charge the first to fourth capacitors, a positive semi-cycle voltage signal of a voltage signal outputted by the data end conducts the fifth electric switch to perform supplementary charge to the third and fourth capacitors, and a negative semi-cycle voltage signal of the voltage signal outputted by the data end closes the fifth electric switch to stop supplementary charge to the third and fourth capacitors. The second electric switch and the fourth electric switch are coupled in parallel. For the pixel unit in the sub area, as the second to fourth electric switches are all activated, and the charging voltage is in the positive semi-cycle, the fifth electric switch is activated, and the charging voltage charges the third and fourth capacitors at the same time through the second electric switch, the fourth electric switch and the fifth electric switch, and the charging ability in the positive semi-cycle is enhanced, and relatively the discharging ability is enhanced; in the negative semi-cycle, the fifth electric switch is closed, and only the second electric switch charges the third and fourth capacitors, and the charging and discharging abilities are unchanged. In the sub area, the voltage level of the charging voltage in the pixel unit is raised in positive semi-cycle, and the voltage level is unchanged in the negative semi-cycle, then, the common end voltage in the middle of the positive semi-cycle and the negative semi-cycle rises, and thus becomes consistent with the common end voltage of the pixel unit in the main area. The flicker situation happening to the liquid crystal display is solved, and thus to promote the quality of the liquid crystal display.

### BRIEF DESCRIPTION OF THE DRAWINGS

In order to more clearly illustrate the embodiments of the present invention, the following figures will be described in the embodiments are briefly introduced. It is obvious that the drawings are only some embodiments of the present invention, those of ordinary skill in this field can obtain other figures according to these figures without paying the premise.

FIG. 1 is a circuit diagram of a liquid crystal driving circuit provided by the first preferred embodiment according to the first solution of the present invention;

FIG. 2 is a circuit diagram of a liquid crystal driving circuit provided by the second preferred embodiment according to the first solution of the present invention.

### DETAILED DESCRIPTION OF PREFERRED EMBODIMENTS

For better explaining the technical solution and the effect of the present invention, the present invention will be further described in detail with the accompanying drawings in the specific embodiments.

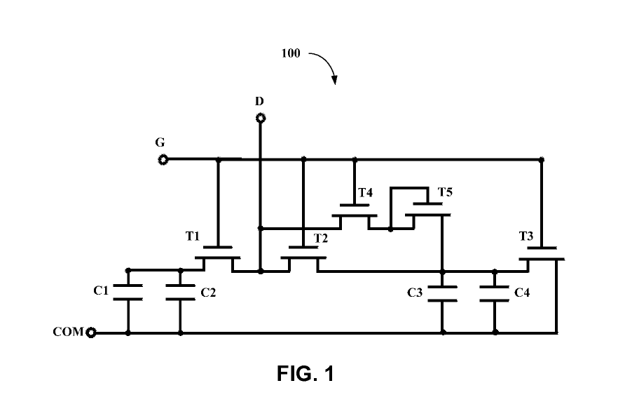

Please refer to FIG. 1. The first preferred embodiment according to the first solution of the present invention provides a liquid crystal driving circuit 100. The liquid crystal driving circuit 100 is employed to charge a pixel unit of a liquid crystal display. The pixel unit comprises a main area and a sub area. The liquid crystal driving circuit 100 comprises a first electric switch T1, a second electric switch T2, a third electric switch t3, a fourth electric switch T4, a fifth electric switch T5, a first capacitor C1, a second capacitor C2, a third capacitor C3 and a fourth capacitor C4. The first, second capacitors C1, C2 are located in the main area. The third, fourth capacitors C3, C4 are located in the sub area. All control ends of the first to fourth capacitors T1-T4 are coupled to a gate control end G to receive a control signal. A first end of the first electric switch T1 is coupled to first ends of the first and second capacitors C1, C2. A second end of the first electric switch T1 is coupled to a first end of the second electric switch T2, and coupled to a data end D to receive a charging voltage. A second end of the second electric switch T2 is coupled to a first end of the third electric switch T3, and coupled to first ends of the third, and fourth capacitors C3, C4. A second end of the third electric switch T3 is coupled to a common voltage end COM. All second ends of the first to fourth capacitors C1-C4 are coupled to the common voltage end COM to receive a common end voltage. A first end of the fourth electric switch T4 is coupled to the data end D to receive the charging voltage. A second end of the fourth electric switch T4 is coupled to a first end of the fifth electric switch T5, and a second end of the fifth electric switch T4 is coupled to the first ends of the third and fourth capacitors C3, C4. As the control signal activates the first to fourth electric switches T1-T4 to charge the first to fourth capacitors C1-C4, a positive semi-cycle voltage signal of a voltage signal outputted by the data end D conducts the fifth electric switch T5 to perform supplementary charge to the third and fourth capacitors C3, C4, and a negative semi-cycle voltage signal of the voltage signal outputted by the data end D closes the fifth electric switch T5 to stop supplementary charge to the third and fourth capacitors C3, C4.

Specifically, for each pixel unit, it is a basic requirement for driving with utilizing the charging voltages of the positive semi-cycle and the negative semi-cycle, alternately to prevent the polarization of the liquid crystal. If the charging voltage larger than the common end voltage is the positive semi-cycle, then the charging voltage smaller than the common end voltage is the negative semi-cycle. The common end voltage is set to be the center of the positive, negative semi-cycles. The pixel unit in the main area has the same charging ability and the discharging ability in the positive semi-cycle, and the pixel unit in the main area has the same charging ability and the discharging ability in the negative semi-cycle, then, the common end voltage is set to be the center of the positive, negative semi-cycles. In the sub area, the charging ability of the pixel unit is weaker than the discharging ability in the positive semi-cycle, and the charging ability is stronger in the negative semi-cycle. Such asymmetry of the charging ability makes that the common end voltage of the pixel unit in the sub area is lower than the common end voltage of the pixel unit in the main area, and the consistency cannot be maintained to result in the image flicker of the liquid crystal display device. In this embodiment, the second electric switch T2 and the fourth electric switch T4 are coupled in parallel. For the pixel unit in the sub area, as the second to fourth electric switches T2-T4 are all activated, and the charging voltage is in the positive semi-cycle, the fifth electric switch T5 is activated, and the charging voltage charges the third and fourth capacitors C3, C4 at the same time through the second electric switch T2, the fourth electric switch T4 and the fifth electric switch T5, and the charging ability in the positive semi-cycle is enhanced, and relatively the discharging ability is enhanced; in the negative semi-cycle, the fifth electric switch T5 is closed, and only the second electric switch charges the third and fourth capacitors C3, C4, and the charging and discharging abilities are unchanged. In the sub area, the voltage level of the charging voltage in the pixel unit is raised in positive semi-cycle, and the voltage level is unchanged in the negative semi-cycle, then, the common end voltage in the middle of the positive semi-cycle and the negative semi-cycle rises, and thus becomes consistent with the common end voltage of the pixel unit in the main area. The flicker situation happening to the liquid crystal display is solved, and thus to promote the quality of the liquid crystal display.

In this embodiment, the first to fourth electric switches T1-T4 are transistors. The control ends, the first ends and the second ends of the first to fourth electric switches T1-T4 respectively are gates, sources and drains of the transistors.

Selectably, the fifth electric switch T5 is a transistor. A first end of the fifth electric switch T5 is a source of the transistor. A second end of the fifth electric switch T5 is a drain of the transistor, and a gate of the transistor is coupled to the source of the transistor.

In this embodiment, the transistors are all NPN-type transistors. In other embodiments, the type of the transistors can be adjusted according to actual demands.

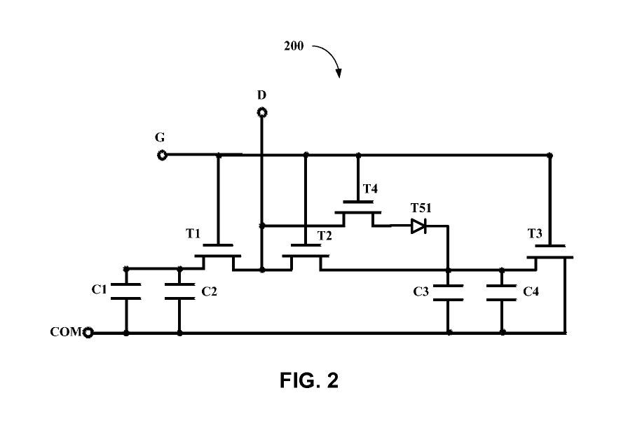

Please refer to FIG. 2. The second preferred embodiment according to the first solution of the present invention provides a liquid crystal driving circuit 200. The liquid crystal driving circuit 200 provided by the second preferred embodiment is similar with the liquid crystal driving circuit 100 provided by the first preferred embodiment. The difference of the two is: in the second preferred embodiment, the fifth electric switch T51 is a diode. A first end of the fifth electric switch T51 is an anode of the diode. A second end of the fifth electric switch T51 is a cathode of the diode.

In other embodiments, the fifth electric switch T51 also can be adjusted according to actual demands as long as it is an element satisfying the single way conduction function.

The preferred embodiment of the second solution of the present invention provides a liquid crystal display device. The liquid crystal display device comprises a pixel unit and a liquid crystal driving circuit, employed to supply power for the pixel unit. The pixel unit comprises a main area and a sub area. In this embodiment, the liquid crystal driving circuit can be the liquid crystal driving circuit 100 provided by the first preferred embodiment of the first solution. In other embodiments, the liquid crystal driving circuit also can be the liquid crystal driving circuit 200 provided by the second preferred embodiment of the first solution.

The structure and function of the liquid crystal driving circuit 100 has already been described in detail in the first solution. The repeated description is omitted here.

For each pixel unit, it is a basic requirement for driving with utilizing the charging voltages of the positive semi-cycle and the negative semi-cycle, alternately to prevent the polarization of the liquid crystal. If the charging voltage larger than the common end voltage is the positive semi-cycle, then the charging voltage smaller than the common end voltage is the negative semi-cycle. The common end voltage is set to be the center of the positive, negative semi-cycles. The pixel unit in the main area has the same charging ability and the discharging ability in the positive semi-cycle, and the pixel unit in the main area has the same charging ability and the discharging ability in the negative semi-cycle, then, the common end voltage is set to be the center of the positive, negative semi-cycles. In the sub area, the charging ability of the pixel unit is weaker than the discharging ability in the positive semi-cycle, and the charging ability is stronger in the negative semi-cycle. Such asymmetry of the charging ability makes that the common end voltage of the pixel unit in the sub area is lower than the common end voltage of the pixel unit in the main area, and the consistency cannot be maintained to result in the image flicker of the liquid crystal display device. In this embodiment, the second electric switch T2 and the fourth electric switch T4 are coupled in parallel. For the pixel unit in the sub area, as the second to fourth electric switches T2-T4 are all activated, and the charging voltage is in the positive semi-cycle, the fifth electric switch T5 is activated, and the charging voltage charges the third and fourth capacitors C3, C4 at the same time through the second electric switch T2, the fourth electric switch T4 and the fifth electric switch T5, and the charging ability in the positive semi-cycle is enhanced, and relatively the discharging ability is enhanced; in the negative semi-cycle, the fifth electric switch T5 is closed, and only the second electric switch charges the third and fourth capacitors C3, C4, and the charging and discharging abilities are unchanged. In the sub area, the voltage level of the charging voltage in the pixel unit is raised in positive semi-cycle, and the voltage level is unchanged in the negative semi-cycle, then, the common end voltage in the middle of the positive semi-cycle and the negative semi-cycle rises, and thus becomes consistent with the common end voltage of the pixel unit in the main area. The flicker situation happening to the liquid crystal display is solved, and thus to promote the quality of the liquid crystal display.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A liquid crystal driving circuit, employed to charge a pixel unit of a liquid crystal display, and the pixel unit comprises a main area and a sub area, wherein: the liquid crystal driving circuit comprises a first electric switch, a second electric switch, a third electric switch, a fourth electric switch, a fifth electric switch, a first capacitor, a second capacitor, a third capacitor and a fourth capacitor, and the first, second capacitors are located in the main area, and the third, fourth capacitors are located in the sub area, all control ends of the first to fourth capacitors are coupled to a gate control end to receive a control signal, and a first end of the first electric switch is coupled to first ends of the first and second capacitors, and a second end of the first electric switch is coupled to a first end of the second electric switch, and coupled to a data end to receive a charging voltage, and a second end of the second electric switch is coupled to a first end of the third electric switch, and coupled to first ends of the third, and fourth capacitors, and a second end of the third electric switch is coupled to a common voltage end, and all second ends of the first to fourth capacitors are coupled to the common voltage end to receive a common end voltage, and a first end of the fourth electric switch is coupled to the data end to receive the charging voltage, and a second end of the fourth electric switch is coupled to a first end of the fifth electric switch, and a second end of the fifth electric switch is coupled to the first ends of the third and fourth capacitors, and as the control signal activates the first to fourth electric switches to charge the first to fourth capacitors, a positive semi-cycle voltage signal of a voltage signal outputted by the data end conducts the fifth electric switch to perform supplementary charge to the third and fourth capacitors, and a negative semi-cycle voltage signal of the voltage signal outputted by the data end closes the fifth electric switch to stop supplementary charge to the third and fourth capacitors.

2. The liquid crystal driving circuit according to claim 1, wherein the first to fourth electric switches are transistors, and the control ends, the first ends and the second ends of the first to fourth electric switches respectively are gates, sources and drains of the transistors.

3. The liquid crystal driving circuit according to claim 2, wherein the fifth electric switch is a transistor, and a first end of the fifth electric switch is a source of the transistor, and a second end of the fifth electric switch is a drain of the transistor, and a gate of the transistor is coupled to the source of the transistor.

4. The liquid crystal driving circuit according to claim 3, wherein the transistors are all NPN-type transistors.

5. The liquid crystal driving circuit according to claim 2, wherein the fifth electric switch is a diode, and a first end of the fifth electric switch is an anode of the diode, and a second switch of the fifth electric switch is a cathode of the diode.

6. A liquid crystal display device, comprising a pixel unit and a liquid crystal driving circuit, employed to charge the pixel unit, and the pixel unit comprises a main area and a sub area, wherein: the liquid crystal driving circuit comprises a first electric switch, a second electric switch, a third electric switch, a fourth electric switch, a fifth electric switch, a first capacitor, a second capacitor, a third capacitor and a fourth capacitor, and the first, second capacitors are located in the main area, and the third, fourth capacitors are located in the sub area, all control ends of the first to fourth capacitors are coupled to a gate control end to receive a control signal, and a first end of the first electric switch is coupled to first ends of the first and second capacitors, and a second end of the first electric switch is coupled to a first end of the second electric switch, and coupled to a data end to receive a charging voltage, and a second end of the second electric switch is coupled to a first end of the third electric switch, and coupled to first ends of the third, and fourth capacitors, and a second end of the third electric switch is coupled to a common voltage end, and all second ends of the first to fourth capacitors are coupled to the common voltage end to receive a common end voltage, and a first end of the fourth electric switch is coupled to the data end to receive the charging voltage, and a second end of the fourth electric switch is coupled to a first end of the fifth electric switch, and a second end of the fifth electric switch is coupled to the first ends of the third and fourth capacitors, and as the control signal activates the first to fourth electric switches to charge the first to fourth capacitors, a positive semi-cycle voltage signal of a voltage signal outputted by the data end conducts the fifth electric switch to perform supplementary charge to the third and fourth capacitors, and a negative semi-cycle voltage signal of the voltage signal outputted by the data end closes the fifth electric switch to stop supplementary charge to the third and fourth capacitors.

7. The liquid crystal display device according to claim 6, wherein the first to fourth electric switches are transistors, and the control ends, the first ends and the second ends of the first to fourth electric switches respectively are gates, sources and drains of the transistors.

8. The liquid crystal display device according to claim 7, wherein the fifth electric switch is a transistor, and a first end of the fifth electric switch is a source of the transistor, and a second end of the fifth electric switch is a drain of the transistor, and a gate of the transistor is coupled to the source of the transistor.

9. The liquid crystal display device according to claim 8, wherein the transistors are all NPN-type transistors.

10. The liquid crystal display device according to claim 7, wherein the fifth electric switch is a diode, and a first end of the fifth electric switch is an anode of the diode, and a second switch of the fifth electric switch is a cathode of the diode.
